(19) United States
(12) Patent Application Publication
(10) Pub. No.: US 2008/0087802 A1
(43) Pub. Date: Apr. 17, 2008

(54) OPTICAL PICKUP DEVICE

(76) Inventors: YOSHIO OZEKI, Yokohama (JP); Hiroaki Furuichi, Kawasaki (JP); Rika Nomura, Yokohama (JP); Kazuyuki Fukuda, Kasumigaura (JP); Taketoshi Moriyama, Hanamaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/843,681

(22) Filed: Aug. 23, 2007

(30) Foreign Application Priority Data
Oct. 16, 2006 (JP) 2006-281050

(51) Int. Cl. G02B 27/00

(52) U.S. Cl. 250/216

(57) ABSTRACT

In an optical pickup device, a side surface parallel in the optical axis direction of an optical component is respectively fixed with an adhesive at wall surfaces (internal walls) provided opposing with each other of an accommodation case. In a part of the wall surfaces of the accommodation case, a recessed channel to be filled with the adhesive is formed. The recessed channel is provided with a stepped portion along the optical axis of the optical component at the wall surfaces of the accommodation case. A gap between the relevant side surfaces and the side surface of the optical component is formed to be reduced symmetrically toward both end portions from the center in the optical axis direction of the optical component. Accordingly, bonding strength is never lowered and position of the optical pickup device is stably maintained in an optical system.

### CLAIM OF PRIORITY

The present application claims priority from Japanese application JP2006-281050 filed on Oct. 16, 2006, the content of which is hereby incorporated by reference into this application.

### BACKGROUND OF THE INVENTION

(1) Field of the Invention

The present invention relates to an optical pickup device for recording and reproduction of an optical storage medium such as CD and DVD, etc.

(2) Description of the Related Art

An optical pickup device used for recoding and reproduction in an optical disk drive apparatus utilizing an optical recording medium (optical disk) such as CD and DVD is arranged to be movable in the radius direction of the disk while it is facing to the surface of optical disk in the upper and lower directions. A structure of the optical pickup device includes, at the interior of an accommodation case thereof, a light emitting element such as a laser diode, an optical system for guiding the light emitted from the light emitting element to an objective lens via various lenses, prism, and mirror, etc. to focus the light on an optical recording medium, and a photoelectric conversion element for converting the received light into an electrical signal. Of these elements, optical components such as various lenses are fixed to the accommodation case of the optical pickup device using an adhesive for the arrangement at the optimum position on each light path when the light is received. In this case, when the optical pickup device is formed thick (the size in the vertical direction to the surface of recording medium), both side surfaces and the bottom surface of the optical components may be bonded to the accommodation case. However, if the optical pickup device is formed thin not resulting in the space for bonding to the bottom surface, only both side surfaces of the optical component are bonded to the accommodation case.

Japanese Patent Application Laid-Open Publication No. H11-110800 discloses a mounting structure wherein the optical component for focusing the optical beam to the optical disk is bonded at both side surfaces thereof. According to the mounting structure of this Japanese Patent Application Laid-Open Publication No. H11-110800, a filling part of the adhesive for bonding the optical component at the internal circumferential surface of a mounting opening to which the optical component is mounted is formed in the depth corresponding to the intermediate part in the thickness direction of the mounting opening, namely formed in the step-by-step structure. Moreover, Japanese Patent Application Laid-Open Publication No. H11-110800 further describes that the optical component can be bonded and fixed stably as a result in the manner that the adhesive is adhered only to the side surface of the optical component and never diffuses to the rear surface side and front surface side for the optical component inserted into the mounting opening.

### SUMMARY OF THE INVENTION

In the case where only both sides of an optical component are bonded within an accommodation case of an optical pickup, problems that bonding strength may be lowered and an optical axis may be deviated due to gradual progress in peeling at the bonding interface are easily generated, because stress generated by change in the environment such as temperature rise is applied in direct to the bonding part. Therefore, even in the case where only both sides of the optical component are bonded to the accommodation case, bonding and fixing technology for stably holding positional accuracy is required without any lowering of bonding strength.

In the technology described in Japanese Patent Application Laid-Open Publication No. H11-110800, an optical component can be bonded and fixed in the predetermined condition with reference to the bottom surface of an opening and therefore the front and rear surfaces are never contaminated with an adhesive. However, it is difficult to stably maintain positional accuracy of the optical component for change in environment such as temperature rise, etc. A reason is that mounting structure of the optical component including a filling part is non-symmetrical in both upper and lower directions. Namely, when an adhesive is thermally expanded, a compressing force to the optical component is never balanced in the bottom surface side and the upper surface side. Moreover, when a mounting member is thermally expanded, it lifts up the optical component only in the upper direction. Accordingly, mispositioning may easily be generated in the upper and lower directions (optical axis direction).

Japanese Patent Application Laid-Open Publication No. H11-110800 does not relate to a structure that an optical component is bonded in direct to an accommodation case but to a structure that an optical component is bonded to a mounting member which may be adjusted in the mounting position with a drive mechanism (biaxial actuator). Therefore, even if the optical component is displaced in the upper and lower directions with environmental change, such mispositioning can be absorbed with positional adjustment. Moreover, since Japanese Patent Application Laid-Open Publication No. H11-110800 discloses a structure based on that an optical component is mounted by inserting the same into a mounting opening from the upper direction, it is difficult to employ a mounting structure that a recessed filling part is provided at the intermediate part in a vertically symmetrical shape. In addition, in the case of the vertically symmetrical structure, hardening is likely to become insufficient, on the occasion that a adhesive is hardened with the ultraviolet ray, because the ultraviolet ray is irradiated insufficiently to the adhesive at the recessed filling part.

A bonding and fixing technology described in the present invention is based, in view of realizing low cost and reduction in thickness of an optical pickup device, on that an optical component is bonded in direct to an accommodation case and positional adjustment is not performed after the bonding process.

Therefore, an object of the present invention is to provide an optical pickup device for stably maintaining positional accuracy without lowering of bonding strength even in the case where only both sides of the optical component are bonded to the accommodation case.

The optical pickup device of the present invention includes an objective lens for condensing and radiating an optical beam to an optical recording medium, an optical component for transmitting the optical beam among a light emitting element, a photoelectric converting element, and the objective lens and having an optical axis within the plane parallel to an optical pickup device placing surface, and an accommodation case for accommodating the objective lens and the optical component and adhesively fixing the side surface parallel to the optical axis direction of the optical component with an adhesive. Moreover, the adhesive fixing structure may be attained by making smaller a gap (a) at both end portions in the optical axis direction than a gap (b) at the center in the optical direction in regard to a gap for bonding between a side surface to be bonded of the optical component and a side surface to be bonded of the accommodation case provided opposing to the side surface of the optical component.

Here, a recessed channel to be filled with an adhesive is formed at the center in the optical axis direction to the side surface to be bonded of at least any of the accommodation case or the optical component. The recessed channel to be filled with the adhesive is constituted in the manner that a stepped portion thereof is formed as a sloping surface and a gap for bonding is formed to become smaller almost symmetrically toward both end portions from the center in the optical axis direction. Moreover, the recessed channel to be filled with the adhesive is formed through the accommodation case or the optical component in the height direction thereof. The adhesive fills the recessed channel covering the same and is also formed to the region, except for the circumference of the side surface of the optical component.

According to an aspect of the present invention, since an optical component may be held in a stable positional accuracy thereof without lowering of bonding strength even in the case where only both sides of the optical component are bonded in direct to the accommodation case, stable performance can be provided even for environmental change.

### BRIEF DESCRIPTION OF THE DRAWINGS

These and objects as well as advantages of the present invention will become clear by the following description of preferred embodiments of the present invention with reference to the accompanying drawings, wherein:

FIG. 1 is a decomposed structural perspective view (first embodiment) showing an embodiment of an optical pickup device in relation to the present invention;

FIGS. 2A to 2C are diagrams (second embodiment) showing an example of a bonding structure of an optical component 1 and an accommodation case 2 in FIG. 1;

FIGS. 3A and 3B are diagrams showing an example of a forming region of an adhesive 3 in FIG. 2;

FIGS. 4a to 4G are diagrams (third embodiment) showing the other examples of a bonding structure of the optical component 1 and the accommodation case 2 in FIG. 1;

FIGS. 5A to 5D are diagrams (fourth embodiment) showing the other example of a bonding structure of the optical component 1 and the accommodation case 2 in FIG. 1;

FIGS. 6A and 6B are diagrams showing an example of a forming region of an adhesive 3 in FIGS. 5A to 5D;

FIGS. 7A to 7C are diagrams (fifth embodiment) showing the other example of a bonding structure of the optical component 1 and the accommodation case 2 in FIG. 1; and

FIGS. 8A and 8B are diagrams (sixth embodiment) showing the other example of a bonding structure of the optical component 1 and the accommodation case 2 in FIG. 1.

### DETAILED DESCRIPTION OF THE PREFERRED EMBODIMENTS

The preferred embodiments of the present invention will be described with reference to the accompanying drawings.

### First Embodiment

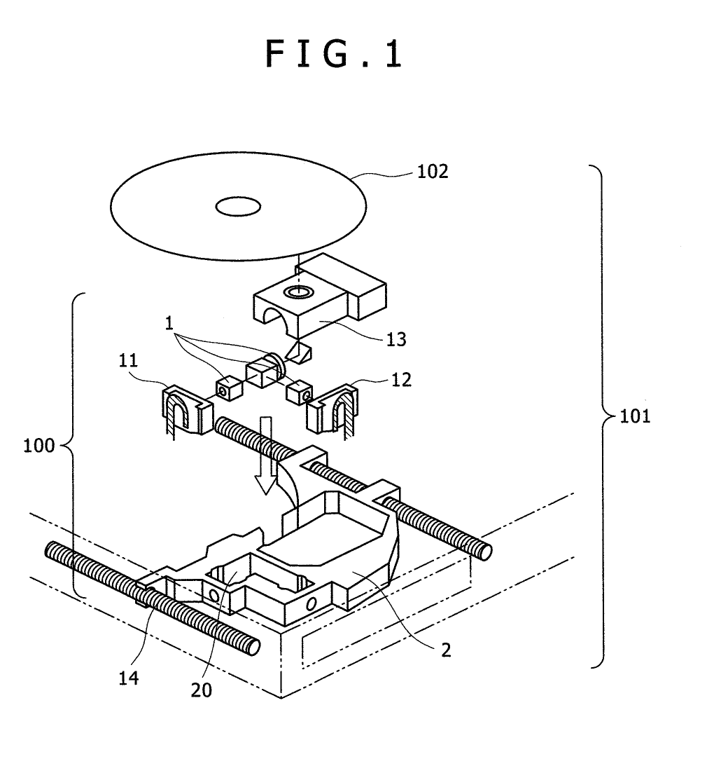

FIG. 1 is a decomposed structural perspective view showing a preferred embodiment of an optical pickup device 100 of the present invention. In FIG. 1, the optical pickup device of the present invention is built into an optical disk drive 101. The optical pickup device 100 fixes an optical component 1 of various kinds, a light emitting element 11 such as a laser diode, a photoelectric converting element 12, and an objective lens 13, etc. by mounting these elements to an accommodation case 2 (also defined as an accommodation case). An optical beam emitted from the light emitting element 11 is transmitted to the objective lens 13 via the optical component 1 of various kinds and is then condensed and radiated to an optical recording medium (optical disk) 102 provided opposed to the objective lens 13. Moreover, a reflected light from the optical disk 102 is condensed with the objective lens 13, transferred to the photoelectric converting element 12 via an optical component 1 of various kinds and then converted into an electric signal. In this case, an optical path (optical axis) for each optical component 1 is formed within a plane almost parallel to a surface of the optical disk 102, in other words, within a plane parallel to a placing surface of the optical pickup device 100 (or accommodation case 2) as will be understood from arrangement in FIG. 1. The optical pickup device 100 is driven with a motor not shown and moves in the radius direction of the optical disk 102 along a guide rail 14.

The optical component 1 includes various lenses such as a grating lens, a coupling lens, and a detector lens. These lenses give large influence on an optical transmission characteristic and must be maintained in higher positional accuracy at the optimum position on the optical path. Therefore, the optical component 1 fixed in direct with an adhesive supplied to the predetermined position of an accommodating part 20 in the accommodation case 2. In this case, in view of reduction in thickness of the optical disk drive 101, the optical pickup device 100 is formed thin through restriction on height and thickness (depth of accommodating part 20) thereof. Accordingly, each optical component 1 is constituted in the structure that it cannot be bonded in the bottom surface side and is bonded to the internal circumferential surface of the accommodation case 2 only at both side surfaces.

Various lenses considered as the optical component 1 are constituted with a die casting material mainly formed of any material of at least polyolefin and acryl. The accommodation case 2 is constituted with a die casting material mainly formed of any material of at least Zn, Mg, Al, and PPS (polyphenylen sulfide). Moreover, as an adhesive, a material that is hardened with irradiation of ultraviolet ray is used. This material is supplied into a gap between the optical component 1 and the accommodation case 2. This adhesive may be hardened, for example, with irradiation of the ultraviolet ray from the upper direction or the lower direction of the accommodation case 2.

For the optical pickup device 100, tolerance for mispositioning of the optical component 1 becomes more severe with further improvement in performance and thickness. Meanwhile, with further improvement in performance, heat generated from each optical element increases in quantity. If such heat is transferred to the adhesive 3 and the optical component 1 via the accommodation case 2, stress due to difference in the thermal expansion coefficients of members may be generated in the adhesive 3. Particularly, since the thin optical pickup device 100 described above has a structure that only both side surfaces of the optical component 1 are fixed to the accommodation case 2 with the adhesive 3, stress of the adhesive 3 increases. Such stress of the adhesive 3 is also generated with an environmental load. Such stresses bring about peeling and reduction in strength of the adhesive 3 and also cause mispositioning of the optical component 1. Therefore, it has been requested to provide a structure that can reduce as much as possible such stresses and does not easily generate mispositioning even if stresses are generated.

### Second Embodiment

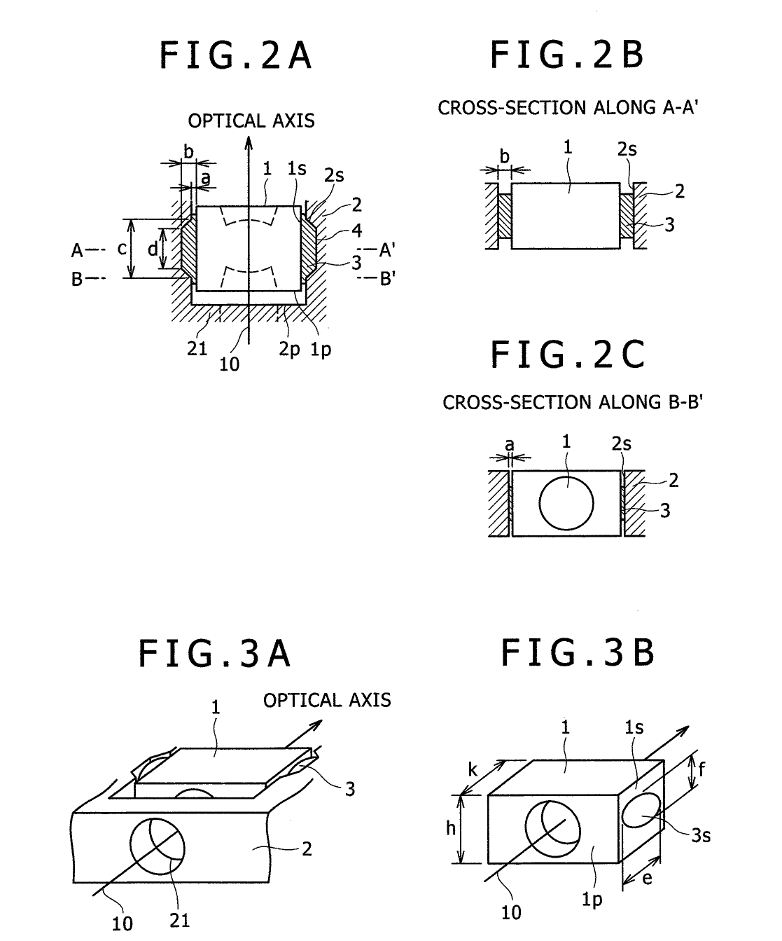

FIGS. 2A to 2C are diagrams showing an example of a bonding structure of the optical component 1 and the accommodation case 2 in the optical pickup device of FIG. 1.

FIG. 2A is a plan view observed from the upper part of the accommodation case 2 (inserting side of the optical component 1). FIGS. 2B and 2C are cross-sectional views observed from the plane perpendicular to the optical axis. The optical component 1 is arranged to the optimum position for the optical axis 10 within the accommodation case 2 and the side surfaces 1s in both sides parallel to the optical axis 10 of the optical component 1 and each side surface 2s of the accommodation case provided opposing to both side surfaces are bonded and fixed with the adhesive 3. In this case, a plane 1p in the optical axis direction of the optical component 1 is not in contact with a plane 2p in the optical axis side of the accommodation case 2 and are arranged in separation. In the arrangement described above, the optical pickup device of this embodiment is formed in the structure that stress of the adhesive 3 is reduced as much as possible even when environmental change occurs and that mispositioning (particularly, mispositioning in the optical axis direction) of the optical component 1 is not easily generated even if stress is generated.

In this embodiment, a recessed channel 4 to be filled with the adhesive is formed through the accommodation case 2 in the height (depth) direction at the center of the bonding surface in the optical axis direction for the side surface 2s as the bonding surface of the accommodation case 2 as shown in FIG. 2A. As a result, a larger bonding gap (b) for the optical component 1 is attained at the center in the optical axis direction as shown in the cross-section along A-A′ in FIG. 2B, while a smaller bonding gap (a) is attained at the end part in the optical axis direction as shown in the cross-section along B-B′ in FIG. 2C (a<b). In more concrete, the gap (a) equal to or less than 1 mm is preferable. Naturally, the adhesive 3 supplied to fill the gap is formed thick at the center and formed thin at the end part. In this case, the recessed channel 4 is formed in the shape to the stepped portion as a sloping surface and the side surface 2s to be bonded is formed in the shape almost symmetrical in the optical axis direction. Accordingly, the gap for bonding is made smaller almost symmetrically toward both end portions from the center in the optical axis direction.

According to the structure of the bonding surface in this embodiment, peeling of bonded area can be prevented by remarkably reducing stress that is assumed as a reason of peeling at the bonded area, because thickness of adhesive at the end part of the bonding surface (=a) is thinner than that in the structure of the related art where the bonding gap is formed in the uniform width. Moreover, since the adhesive at the center of the bonding surface (=b) is formed thick, sufficient bonding strength of the adhesive for the coated region and the optical component 1 can be assured. Furthermore, since the accommodation case 2 and its bonding surface for the optical component 1 are shaped almost symmetrically toward both end portions in the optical axis direction, if each member generates thermal expansion due to temperature change, expansion forces of these elements are balanced and therefore the optical component 1 is never mispositioned in the optical axis direction. In addition, since the surface 1p of the optical component 1 in the optical axis direction is never in contact with the surface 2p of the accommodation case 2, the optical component 1 is never mispositioned in the optical axis direction, even if the accommodation case 2 is thermally expanded.

Moreover, in this embodiment, the recessed channel 4 is shaped to form the stepped portion thereof as the sloping surface. Namely, the recessed channel 4 is formed to bring about the width (c) at the upper end of the sloping surface that is larger than the width (d) at the lower end of the sloping surface (c>d). Therefore, thickness of the adhesive at the stepped portion of the recessed channel 4 is gradually reduced to further reduce the stress thereof. Accordingly, peeling of the bonded area, reduction in bonding strength, and mispositioning of the optical component 1 resulting from such phenomena due to formation of the recessed channel can be prevented.

Moreover, the recessed channel 4 is formed through the depth direction of the accommodation case 2 in the identical shape of the cross-section. Accordingly, the ultraviolet ray is irradiated along the direction of the recessed channel 4 from the upper or lower direction of the accommodation case 2 to equally irradiate the adhesive 3 supplied to fill the gap. As a result, not only the stable hardening characteristic of the adhesive 3 can be assured but also easier hardening work of the adhesive can be achieved. Here, it may be possible that the recessed channel 4 is not formed through the depth direction of the accommodation case 2 and is formed in the identical shape of cross-section at least within the range of the bonding region. In this case, the ultraviolet ray is irradiated only from the selected one direction.

As the adhesive 3, an acrylic or epoxy system adhesive that is hardened with radiation of the ultraviolet ray is preferable. Moreover, the adhesive having the glass transition temperature resulting in a comparatively lower bonding strength may also be used. In addition, in order to improve the bonding strength, it is also preferable for the surface of the bonding region of the accommodation case 2 that the Blast processing that is generally conducted for the die-casting material is implemented to form fine crenelation in the average size of about several μm.

FIGS. 3A and 3B are diagrams showing an example of a forming region (bonding region) of the adhesive 3 in the bonding structure of FIGS. 2A to 2C. FIG. 3A is a perspective view of the entire part of the accommodation case 2. FIG. 3B is a perspective view showing the bonding region 3s at the side surface of the optical component 1 after the accommodation case 2 is removed. The adhesive 3 is never formed to the entire surface of the side surface is of the optical component 1 but is formed in the region other than the periphery of the side surface is. Namely, when sizes of the side surface is of the optical component 1 are determined that length in the optical axis direction is (k) and height is (h), and when sizes of the region 3s corresponding to above sizes are (e), and (f), respectively, relationships of e<k and f<h are determined. Therefore, the adhesive 3 is never adhered to the peripheral part of the side surface is, not deteriorating the surface 1p in the optical axis side of the optical component 1.

In addition, it is preferable that the region 3s is formed to satisfy the relationship of e>f for the sizes e and f. Namely, in the case where the size (e) in the optical axis direction of the region 3s of the adhesive is determined larger, the adhesive 3 is fully supplied covering the recessed channel 4 in the width direction thereof and bonding strength can be stabilized under the condition that the adhesive 3 reaches the region where the bonding gap=(a) is achieved. These sizes of the bonding region 3s may be controlled with amount of supply and supply position of the adhesive 3.

### Third Embodiment

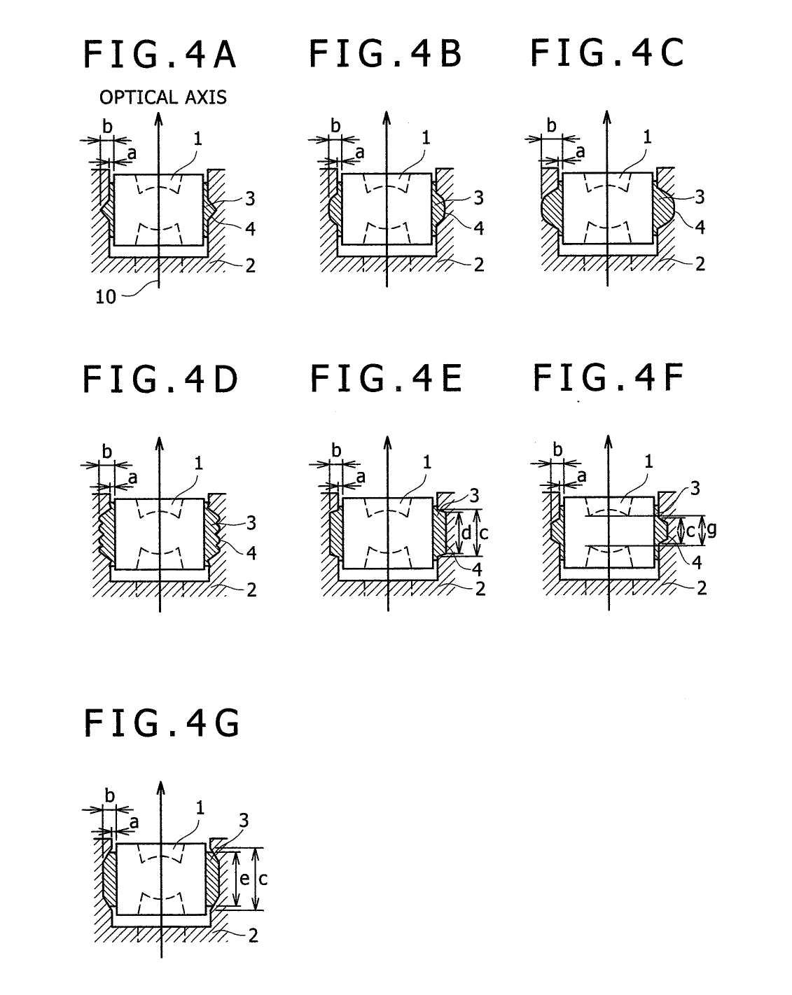

FIGS. 4A to 4G are plan views showing the other example of the bonding structure of the optical component 1 and the accommodation case 2 in the optical pickup device of FIG. 1. Like the second embodiment, the recessed channel 4 to be filled with the adhesive is formed in the height (depth) direction through the side surface to be bonded of the accommodation case 2. In this third embodiment, the recessed channel 4 is formed in various shapes. The bonding gap (b) at the center in the optical axis direction and the bonding gap (a) at both end portions are structured to result in the relationship of a<b and the adhesive fixing process is conducted using the adhesive 3.

In FIG. 4A, the recessed channel 4 is formed in the shape of character V, while in FIG. 4B, the recessed channel 4 is formed in the semi-elliptical shape, while in FIG. 4C, the recessed channel 4 is formed in the semi-circular shape. In FIG. 4D, the saw-tooth shape crenelation is provided at the bonding surface and the bonding gaps (a) and (b) are determined as the average values of crenelation. In FIG. 4E, the stepped portion of the recessed channel 4 is formed as the sharp sloping surface (namely, difference in sizes (c) and (d) is set extremely small). In FIG. 4F, width (c) of the recessed channel 4 is set in the relation of c<g for the shortest lens-to-lens distance (g) in the optical axis direction of the optical component 1. Moreover, in FIG. 4G, a size (e) in the optical axis direction of the region that is filled with the adhesive 3 is limited up to both sloping positions of the recessed channel 4 (namely, e<c).

Even in these examples of structure, since the adhesive (=a) at both end portions of the bonding surface is formed thin, peeling of the bonded area can be prevented by remarkably reducing stress that is considered as a cause of peeling at the bonded area. Moreover, since the bonding surface of the accommodation case 2 is formed almost symmetrically toward both end portions of the bonding surface, expansion force of each member due to temperature change is well balanced and the optical component 1 is never mispositioned in the optical axis direction.

### Fourth Embodiment

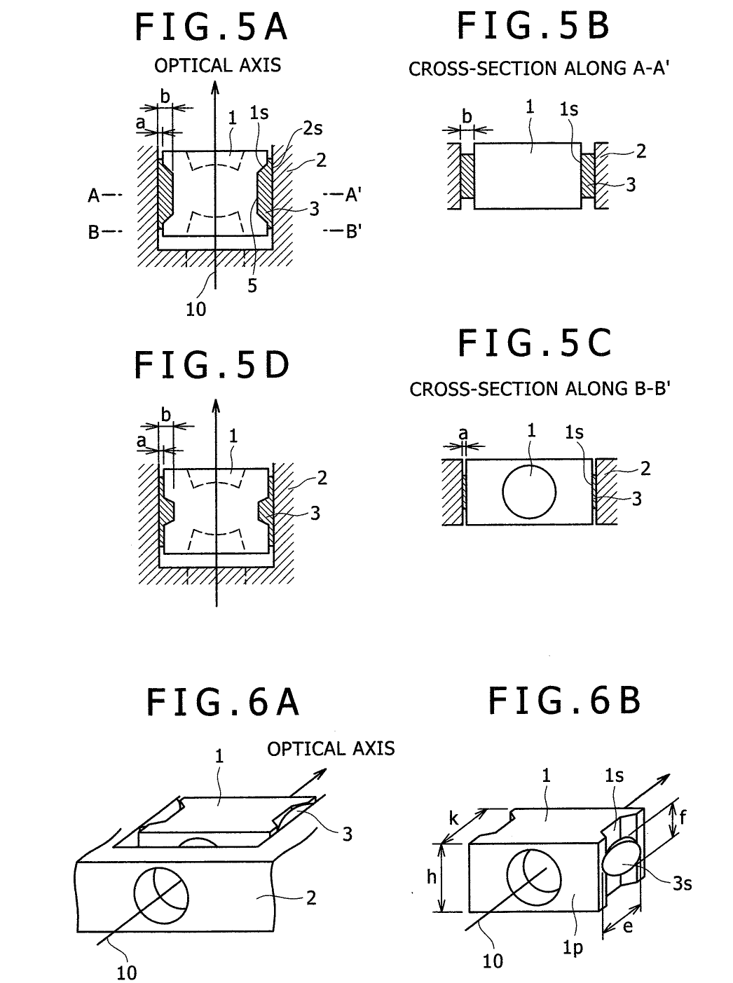

FIGS. 5A to 5D are diagrams showing the other example of the bonding structure of the optical component 1 and the accommodation case 2. FIG. 5A is a plan view observed from the upper direction of the accommodation case 2, while FIGS. 5B and 5C are cross-sectional views observed from the plane perpendicular to the optical axis. In this fourth embodiment, the recessed channel 5 to be filled with the adhesive is formed through the optical component 1 in the height (depth) direction to the side surface 1s of both sides as the bonding surface of the optical component 1. The side surface 2s as the bonding surface of the accommodation case 2 should be formed flat. As shown in FIG. 5A, the recessed channel 5 is formed at the center in the optical axis direction in the shape that the stepped portion is formed as the sloping surface. As a result, a large bonding gap (b) is given for the accommodation case 2 at the center in the optical axis direction as shown in FIG. 5B, and a small bonding gap (a) is given at the end part in the optical axis direction as shown in FIG. 5C (a<b). Here, the recessed channel 5 may also be formed in the shape of each example of structure shown in the second embodiment or third embodiment. For example, length of the channel 5 (size along the bonding surface 2s of the accommodation case) may be set shorter then the radius of curvature of the lens formed to the optical component 1 as shown in FIG. 5D.

FIGS. 6A and 6B are diagrams showing an example of the forming region (bonding region) of the adhesive 3. FIG. 6A is an entire perspective view of the accommodation case 2 and FIG. 6B is a perspective view showing the bonding region 3s at the side surface of the optical component 1 after the accommodation case 2 is removed. Like the FIGS. 3A and 3B described above, the adhesive 3 is not formed to the entire surface of the side surface 1s of the optical component 1 but is formed in the region 3s other than the periphery. Moreover, when sizes of the region are defined as (e) and (f), the adhesive 3 is preferably formed under the condition satisfying the relationship of e>f.

In this embodiment, peeling of bonded area can be prevented by remarkably reducing stress that is a cause of peeling of the bonded area, because thickness of the adhesive (=a) at the end part of the bonding surface is rather small. Moreover, since the bonding surface of the optical component 1 is formed in the shape almost symmetrical toward both end portions of the bonding surface, expansion force of each member due to temperature change is well balanced and the optical component 1 is never mispositioned in the optical axis direction.

### Fifth Embodiment

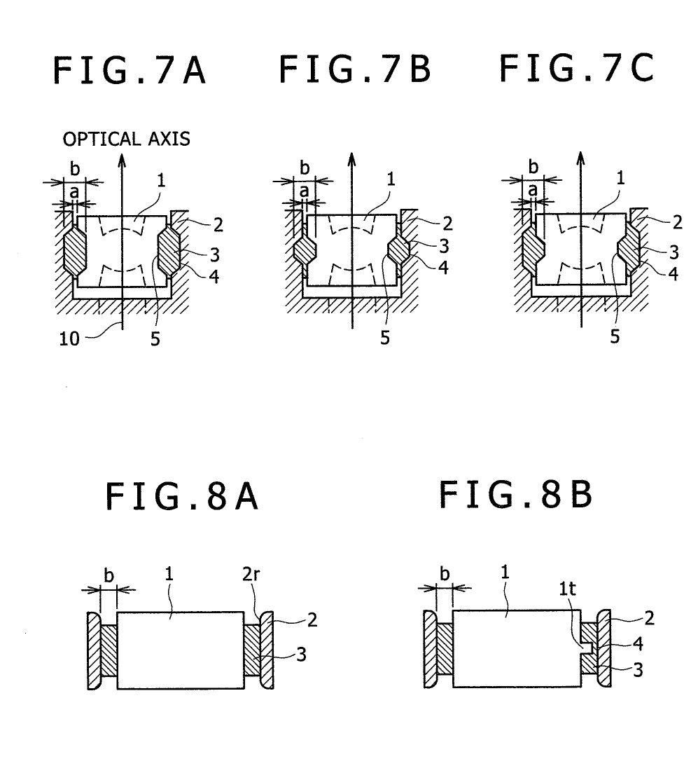

FIGS. 7A to 7C are diagrams (plan views) showing the other example of the bonding structure of the optical component 1 and the accommodation case 2 in the optical pickup device of FIG. 1. In this embodiment, the recessed channels 4, 5 to be filled with the adhesive are formed in both side surface 2s of the accommodation case 2 and the side surface is of the optical component 1. In FIGS. 7A and 7B, the recessed channels 4, 5 have equal width, while in FIG. 7C, the recessed channels 4, 5 have different widths. In any case described above, the larger bonding gap (b) is given at the center in the optical axis direction, while the smaller bonding gap (a) is given at the end part in the optical axis direction (a<b). This embodiment also provides the effect similar to that of the embodiments described above. Moreover, depth of the recessed channels 4, 5 that are required for obtaining the predetermined bonding gap (b) may be reduced to a half by forming the recessed channels to both accommodation case 2 and the optical component 1.

### Sixth Embodiment

FIGS. 8A and 8B are diagrams showing the other example of the bonding structure of the optical component 1 and the accommodation case 2 in the optical pickup device of FIG. 1, namely the cross-sectional views thereof observed from the optical axis direction. FIG. 8A is the cross-sectional view where the upper and lower corners 2r of the accommodation case 2 are angled (chamfered) in order to make easier the inserting work of the optical component 1. In this case, the recessed channel is not shown but may be provided to any of the accommodation case 2 and the optical component 1. The adhesive 3 is supplied to the gap between these elements avoiding the corners 2r. FIG. 8B is the cross-sectional view where the side surface of the optical component 1 is never formed flat and includes a projected part 1t. In this case, bonding with the accommodation case 2 may be realized while the projected part it is left as it is, by forming the recessed channel 4 including the stepped portion that is equal to or larger than the projected part it is formed in the side of the accommodation case 2.

The structure of optical pickup device and material of each member described in above embodiments are only an example. The structures attained by modifying or combining as required the structures of the embodiments described above may also be considered as the objects of the present invention. The present invention may be adapted to the optical pickup device using inorganic materials such as the other metal materials and glasses as the materials of the accommodation case and the optical component.

Quality of recording and reproducing signals to and from an optical disk may be improved and more stable performance may also be assured for environmental change by introducing the optical pickup device described above into an optical disk drive.

While we have shown and described several embodiments in accordance with the present invention, it is understood that the same is not limited thereto but is susceptible of numerous changes and modifications as known to those skilled in the art, and we therefore do not wish to be limited to the details shown and described herein but intend to cover all such changes and modifications as are encompassed by the scope of the appended claims.

What is claimed is:

1. An optical pickup device arranged opposing to an optical recording medium to irradiate an optical beam emitted from a light emitting element to the optical recording medium and to convert a reflected light beam into an electrical signal with a photoelectric converting element, the optical pickup device comprising:
an objective lens for condensing and irradiating an optical beam to the optical recording medium;
an optical component for transferring the optical beam among the light emitting element, the photoelectric converting element and the objective lens and including an optical axis within a plane parallel to a placing surface of the optical pickup device, and
an accommodation case for accommodating the objective lens and the optical component and adhesively fixing a side surface parallel to the optical axis direction of the optical component with an adhesive;
wherein, adhesive fixing is conducted by setting a gap (a) at both end portions in the optical axis direction smaller than a gap (b) at the center in the optical axis direction in regard to a gap for bonding of a side surface to be bonded of the optical component and a side surface to be bonded of the accommodation case provided opposing to the side surface of the optical component.

2. The optical pickup device according to claim 1,
wherein a recessed channel to be filled with the adhesive is formed at the center in the optical axis direction to the side surface that is bonded with at least any of the accommodation case and the optical component.

3. The optical pickup device according to claim 2,
wherein a stepped portion of the recessed channel to be filled with the adhesive is formed as a sloping surface and the gap for bonding is constituted to become small almost symmetrically toward both end portions from the center in the optical axis direction.

4. The optical pickup device according to claim 2,
wherein the recessed channel to be filled with the adhesive is formed through the accommodation case or the optical component in the height direction.

5. The optical pickup device according to claim 2,
wherein the adhesive is fully supplied covering the recessed channel and is formed in the region other than the periphery of the side surface of the optical component.

6. An optical pickup device arranged opposing to an optical recording medium to irradiate an optical beam emitted from a light emitting element to the optical recording medium and to convert a reflected optical beam into an electrical signal with a photoelectric converting element, the optical pickup device comprising:
an objective lens for condensing and irradiating the optical beam to the optical recording medium;
an optical component for transferring the optical beam among the light emitting element, the photoelectric converting element, and the objective lens and including an optical axis within a plane parallel to a placing surface of the optical pickup device; and
an accommodation case for accommodating the objective lens and the optical component and adhesively fixing a side surface parallel to the optical axis direction of the optical component with an adhesive;
wherein, adhesive fixing is conducted by setting thickness (a) at both end portions in the optical axis direction smaller than thickness (b) at the center in the optical axis direction in regard to thickness of the adhesive for bonding a side surface of the optical component and a side surface of the accommodation case provided opposing to the side surface of the optical component.

7. The optical pickup device according to claim 6,
wherein the adhesive is formed in thickness that is reduced almost symmetrically toward both end portions from the center in the optical axis direction.
